(19) United States
(12) Patent Application Publication
(10) Pub. No.: US 2011/0061628 A1
(43) Pub. Date: Mar. 17, 2011

(54) Internal combustion engine and starting method thereof

(75) Inventors: Hidehiro Fujita, Kanagawa (JP); Naoki Osada, Kanagawa (JP); Yoshitaka Matsuki, Kanagawa (JP); Masahiko Yuya, Kanagawa (JP); Atsushi Mitsuhori, Kanagawa (JP); Tadanori Yanai, Kanagawa (JP); Takatsugu Katayama, Kanagawa (JP); Shouta Hamane, Kanagawa (JP)

(73) Assignee: NISSAN MOTOR CO., LTD., Yokohama-shi, Kanagawa (JP)

(21) Appl. No.: 10/572,129

(22) PCT Filed: Dec. 28, 2005
(86) PCT No.: PCT/IB2005/054414

§ 371 Date: Mar. 28, 2007

(30) Foreign Application Priority Data
Dec. 28, 2004 (JP) 2004-380654

(51) Int. Cl. F02P 5/04; F02N 11/08

(52) U.S. Cl. 123/406.47; 123/179.4

(57) ABSTRACT

An internal combustion engine is ignition-combustion started with or without cranking by controlling the ignition-combustion based on combustion chamber pressure, or engine temperature, or piston position, or the time elapsed since the engine was stopped, or a combination of these considerations.

### RELATED APPLICATION

The disclosures of Japanese Patent Application No. 2004-380654, filed Dec. 28, 2004, including the specification, claims and drawings, are incorporated herein by reference in its entirety.

### TECHNICAL FIELD

Disclosed herein is an internal combustion engine constructed to be operated according to an improved starting method, particularly without cranking; that is, starting without rotating the crankshaft.

### BACKGROUND

A starting method and apparatus for an internal combustion engine are disclosed, for example, in Laid-open Japanese Patent Application No. H2-271073. Using this apparatus, a cylinder is identified in which the corresponding piston stops after reaching top dead center and before the exhaust stroke takes place. By injecting fuel into the cylinder so identified, and igniting the fuel, the direct-injection internal combustion engine starts without using an additional cranking means (simply referred to hereinafter as a “starter”) such as a cell motor or a recoil starter.

### SUMMARY OF THE INVENTION

The present internal combustion engine is intended to prevent failure of ignition so as to achieve reliable starting without the use of a starter (i.e., without cranking).

The present internal combustion engine comprises a fuel injector for injecting fuel into a combustion chamber to produce an air-fuel mixture in the combustion chamber, an ignition plug for igniting the air-fuel mixture to effect combustion in the combustion chamber, and a controller for controlling combustion to provide torque for starting the engine after the engine has been stopped, wherein the controller adjusts a time interval between the fuel injection and the ignition based on an amount of air in the combustion chamber.

### BRIEF DESCRIPTION OF THE DRAWINGS

These and other features and advantages of the present engine and method will be apparent from the following description, taken in conjunction with the accompanying drawings, in which:

FIG. 1 is a diagrammatic view of the present internal combustion engine according to an embodiment thereof;

FIG. 2 is a chart showing an example of an output signal from a piston sensor;

FIG. 3 is a diagram illustrating a range of air-fuel ratios (mixture ratios) in a combustion chamber for enabling starting without cranking;

FIG. 4 is a flowchart illustrating idle-stop control (shutdown and restarting of the engine) according to a first embodiment;

FIG. 5 is a continuation of the flowchart of FIG. 4;

FIG. 6 is an example of a chart for establishing basic fuel injection quantity and basic ignition delay time;

FIG. 7 is an example of a chart for establishing a first correction coefficient Kf1 for fuel injection quantity;

FIG. 8 is an example of a chart for setting a second correction coefficient Kf2 for fuel injection quantity;

FIG. 9 is an example of a chart for setting a first correction coefficient Kt1 for ignition delay time;

FIG. 10 is an example of a chart for setting a second correction coefficient Kt2 for ignition delay time;

FIG. 11 is a flowchart illustrating idle-stop control (shutdown and restart of the engine) according to a second embodiment; and

FIG. 12 is a continuation of the flowchart of FIG. 11.

### DESCRIPTION OF THE ILLUSTRATED EMBODIMENTS

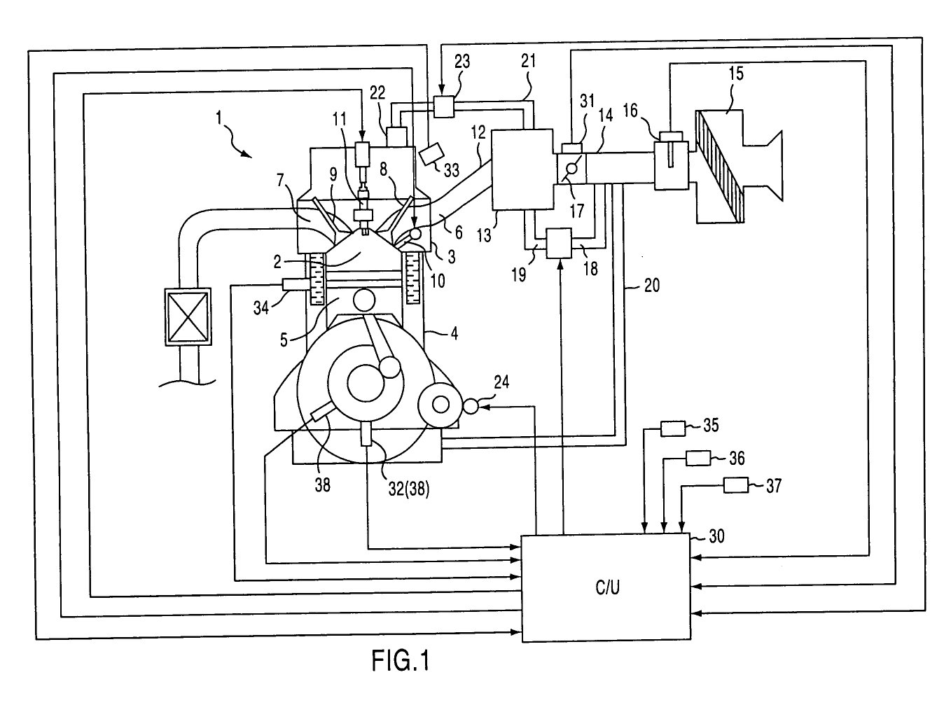

As shown in FIG. 1, a combustion chamber 2 of an engine 1 is formed by a cylinder head 3, a cylinder block 4, and a piston 5 fitted in the cylinder bore of the cylinder block 4. The cylinder head 3 has an intake passage or inlet port 6 and an exhaust passage or exhaust port 7 formed therein, both opening into the combustion chamber 2. An inlet valve 8 and an exhaust valve 9, which open and close ports 6 and 7, are driven by an inlet valve cam and exhaust valve cam (not shown). Meanwhile, a variable valve mechanism (not shown) having a known structure is disposed close to the inlet valve 8 to control the opening and closing times of the inlet valve 8. Alternatively, the variable valve mechanism may be disposed close to the exhaust valve 9.

Disposed in the cylinder head 3 are a fuel injection valve 10 for directly injecting fuel into the combustion chamber 2 and an ignition plug 11 for spark-igniting an air-fuel mixture in the combustion chamber 2, both facing into the combustion chamber 2.

The inlet port 6 is connected with an inlet manifold 12, the inlet manifold 12 being, in turn, connected with an inlet duct 14 upstream thereof, and an inlet collector 13 being interposed therebetween. The inlet duct 14 is provided with an air cleaner 15 for removing dust and so forth from intake air, an airflow meter 16 for detecting the quantity of intake air, and a throttle valve 17 controlling the quantity of intake air, disposed in that order from upstream of the air inlet. A bypass passage 18 extending from the inlet duct 14 upstream of the throttle valve 17 of the inlet duct 14, bypasses the throttle valve 17, and is connected to the inlet collector 13. An idle control valve 19 is disposed in the bypass passage 18 for controlling the quantity of bypassed air.

A first blow-by passage 20 upstream of the throttle valve 17 interconnects the inlet duct 14 and a crankcase in the cylinder block 4 to each other, and a second blow-by passage 21 interconnects a rocker chamber in the head cover of the cylinder head 3 and the inlet collector 13. By means of these blow-by passages 20 and 21, blow-by gas generated in the engine 1 is ventilated by intake air introduced by the inlet duct 14 to the inlet collector 13. Disposed in the second blow-by passage 21 is a pressure control valve (PCV) 22 for controlling the pressure of the blow-by gas and a blow-by control valve 23 controlling the flow rate of the blow-by gas.

The engine 1 is provided with a cranking means or support device such as a starter motor 24 arranged at the lower part thereof, for initiating rotation of the crankshaft.

Transmitted to a control unit or controller (C/U) 30 are signals from a variety of sensors, such as a throttle-valve opening sensor 31 detecting the throttle valve opening (TVO), a crank angle sensor 32, a cam angle sensor 33, a water (coolant) temperature sensor 34, a vehicle speed sensor 35, a gear position sensor 36 detecting the gear position of a transmission, and a brake sensor 37 detecting operation (ON/OFF) of a brake.

On the basis of the detection signals it receives, the C/U 30 controls the variable valve mechanism, the fuel injection valve 10, the ignition plug 11, the throttle valve 17, the idle control valve 19, the blow-by control valve 23, the starter motor 24, and so forth.

The C/U 30 is capable of determining the number Ne of revolutions of the engine on the basis of the detection signal from the crank angle sensor 32 and can also identifying a cylinder on a specified stroke on the basis of the detection signals of the crank angle sensor 32 and the cam angle sensor 33, in addition to determining a stop position of the piston 5. In concrete terms, the stop position of the piston is detected as explained below.

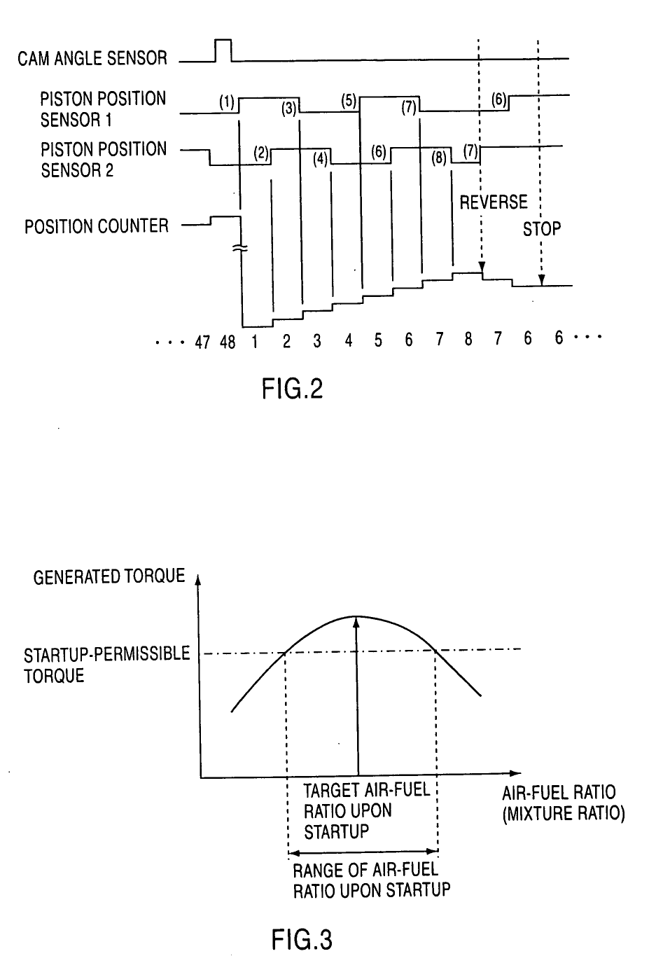

A crank pulley has protrusions (or depressions) disposed every 30 degrees (not shown) and two piston position sensors 38 are arranged in a phase shift of 15 degrees on the periphery thereof (as shown in the figure, the crank angle sensor 32 may be used as either of the piston sensors). The piston position sensors 38 generate ON or OFF signals when protrusions (or depressions) pass therethrough. Then, by sequentially managing rise and fall of the ON or OFF signals of the two piston position sensors 38, a counting operation is conducted. When the order of the ON or OFF signals from the two piston position sensors 38 is reversed (see FIG. 2), a counting-down operation is conducted so that the stop position of the piston 5 is detected on the basis of the count value. Since this serves as only one example of such a method, it will be understood that the stop position of the piston 5 may be obtained different methods.

When predetermined idle-stop conditions are satisfied (for example, when the gear of the transmission is set in the D-range, the brake is in an activated or ON condition, and vehicle speed is zero), the C/U 30 executes idle-stop for automatically shutting down the engine 1. When predetermined idle-stop releasing conditions are satisfied during idle-stop (for example, when the brake is in a deactivated or OFF condition after the idle-stop conditions are satisfied and a driving-off operation is performed by the driver), idle-stop control for releasing the idle-stop and automatically restarting the engine 1 is conducted.

By injecting fuel into a cylinder on an expansion stroke and igniting it, the engine 1 according to the present embodiment restarts without use of a starter (i.e., without cranking). In order to obtain torque (combustion pressure) sufficient to enable starting as shown in FIG. 3, it is necessary to have a mixture ratio (an air-fuel ratio) lying within a predetermined range upon ignition in the combustion chamber 2. Accordingly, in order to more reliably achieve starting without cranking, the following steps are required: (1) accurately determining the quantity of air in the combustion chamber and injecting an appropriate quantity of fuel, and (2), taking account into a vaporization (atomization) characteristic of the injected fuel, whereby ignition may be performed in the most appropriate condition of air-fuel ratio in the combustion chamber. Hence, in the present embodiment, taking account that combustion-chamber pressure (cylinder pressure) will decline due to leaking during shutdown or stopping of the engine, fuel injection quantity and time of ignition for starting are determined.

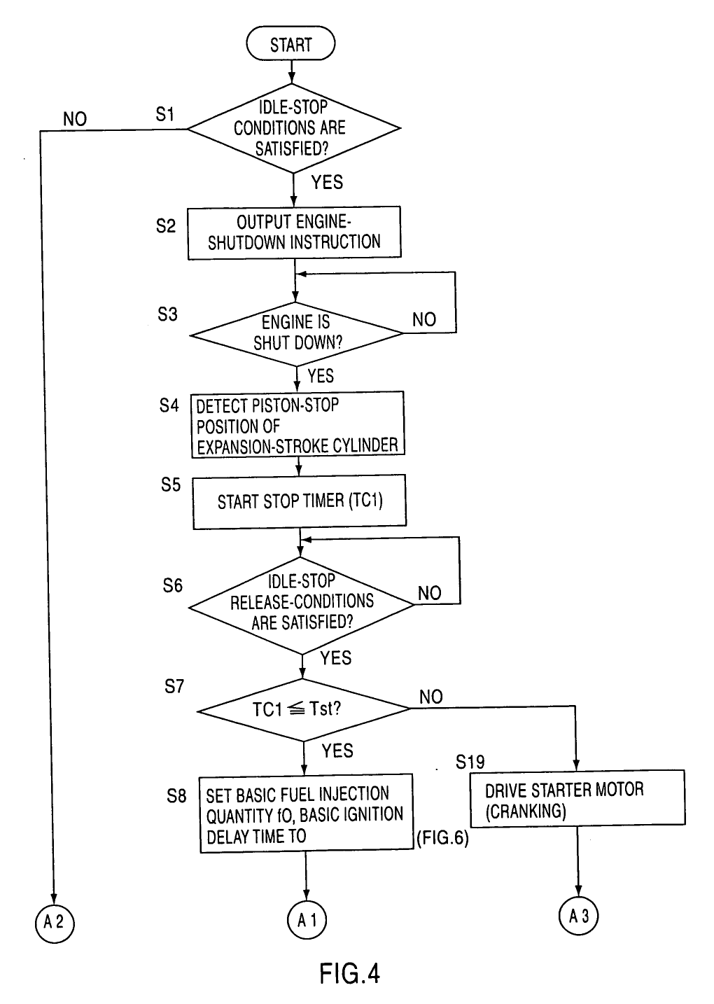

FIGS. 4 and 5 comprise a flowchart illustrating the idle-stop control (shut-down and restart of the engine) executed every predetermined time by the C/U 30.

At step S1, it is determined whether idle-stop conditions are satisfied. If idle-stop conditions are satisfied, the process moves to step S2. If the conditions are not satisfied, the process ends. As described above, while the idle-stop conditions in the present embodiment are satisfied (1) when the gear is set in the D-range, (2) when the car speed is zero (or nearly zero), and (3) when the brake is activated (is ON), the conditions not being limited to these.

At step S2, an instruction to shut down the engine is generated, whereupon the supply of fuel to the respective cylinders is suspended and the engine is shut down.

At step S3, engine shutdown is confirmed, and the process moves to step S4.

At step S4, a cylinder in an expansion stroke and the stop position of its piston (crank stop angle) are detected.

At step S5, the counting operation of a stop timer is started. A count value TC1 of the count timer corresponds to the time elapsed from shutdown of the engine (i.e., from the beginning of the stopping of the engine).

At step S6, it is determined whether idle-stop releasing conditions (in other words, restart conditions) are satisfied. If idle-stop releasing conditions are satisfied, the process moves to step S8, and if not satisfied, the shutdown condition of the engine is maintained without any change. As described above, while the idle-stop releasing conditions are satisfied in the present embodiment, (1) when the brake is OFF, and (2) a driving-off operation (depressing the accelerator for example) is carried out by a driver, the conditions are not limited to these.

At step S7, it is determined whether the count value TC1 of the count timer is equal to or smaller than a predetermined value Tst. If TC1≦Tst; that is, if the elapsed time from shutdown of the engine is within a predetermined range, the process moves to step S8. If TC1>Tst; that is, if the elapsed time from shutdown of the engine exceeds the predetermined range, the process moves to step S19, while presuming that the cylinder pressure has fallen below a predetermined value. Meanwhile, the predetermined value Tst may be constant or set so as to vary, in response, for example, to an operating condition of the engine before the idle-stop conditions were satisfied. Thus, at step S19, initiation of combustion is effected by rotating (cranking) the crankshaft by driving the starter motor 24 and, at the same time, by injecting a predetermined quantity of fuel and performing ignition. In other words, if the time elapsed from shutdown has exceeded the predetermined value, restarting is carried out in the conventional manner.

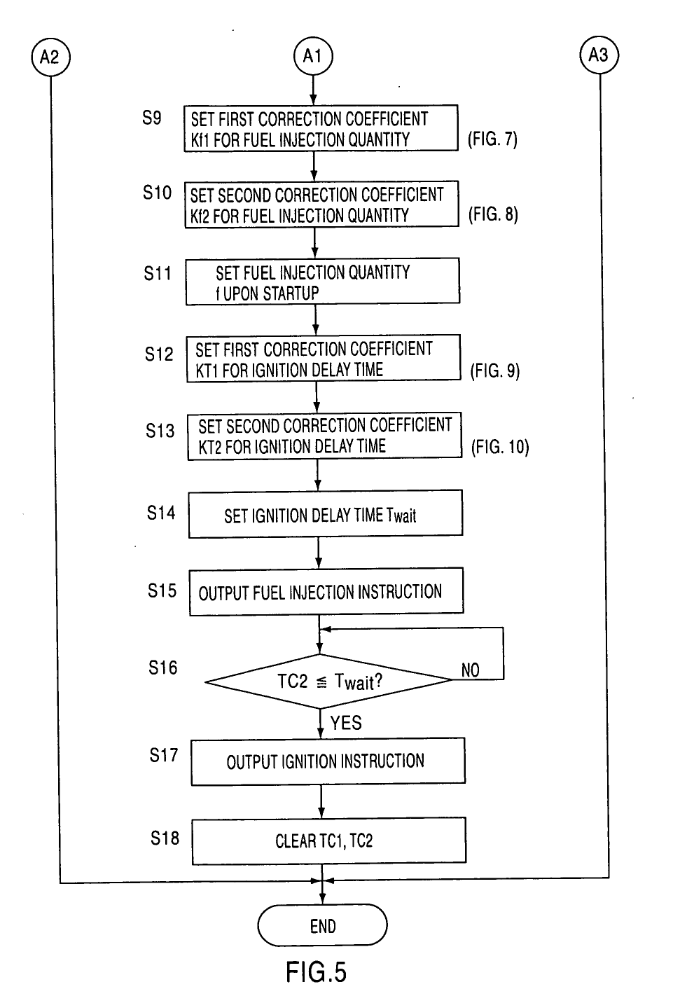

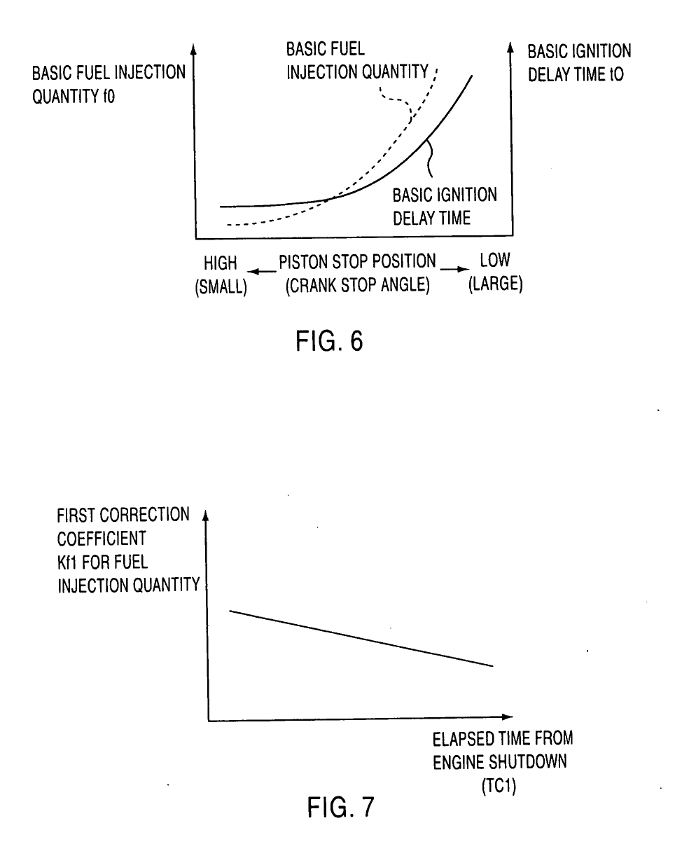

At step S8, on the basis of the stop position of the piston detected at step S4, there are established a basic fuel injection quantity f0 and a basic value (a basic ignition delay time) t0 of a time period (time interval) from fuel injection to ignition of a cylinder on an expansion stroke, according to curves such as those shown in FIG. 6. Combustion chamber volume can be derived from the piston stop position, and, with combustion chamber volume determined, air quantity Q in the combustion chamber can be estimated. Accordingly, by detecting the piston stop position, fuel injection quantity and an ignition-delaying period of time can be set (as reference conditions) for achieving a predetermined target mixture ratio (a target air-fuel ratio upon starting; see FIG. 3). The chart shown in FIG. 6 has been prepared from such considerations.

At step S9, on the basis of the count value TC1 of the count timer (i.e., the elapsed time from shutdown of the engine), a first correction coefficient Kf1 for correcting the basic fuel injection quantity f0 is computed as in the chart shown in FIG. 7. After shutdown of the engine, gas leakage through a piston ring or the like causes a decline in combustion chamber pressure and also the corresponding air density (i.e., air quantity); hence, it is necessary to reduce the fuel injection quantity. The chart shown in FIG. 7 has been prepared from such a consideration. More particularly, the first correction coefficient Kf1 serves for estimating the time-lapse change in cylinder pressure (and the accompanying change in the air quantity) during shutdown of the engine and for correcting the basic fuel injection quantity f0 on the basis of the estimated values. The longer the elapsed time from shutdown of the engine, the greater will be the time-lapse change in the cylinder pressure, and thus the less the fuel injection quantity need be (reduction correction). A fuel pressure sensor may be provided to take fuel pressure into account when establishing the first correction coefficient Kf1.

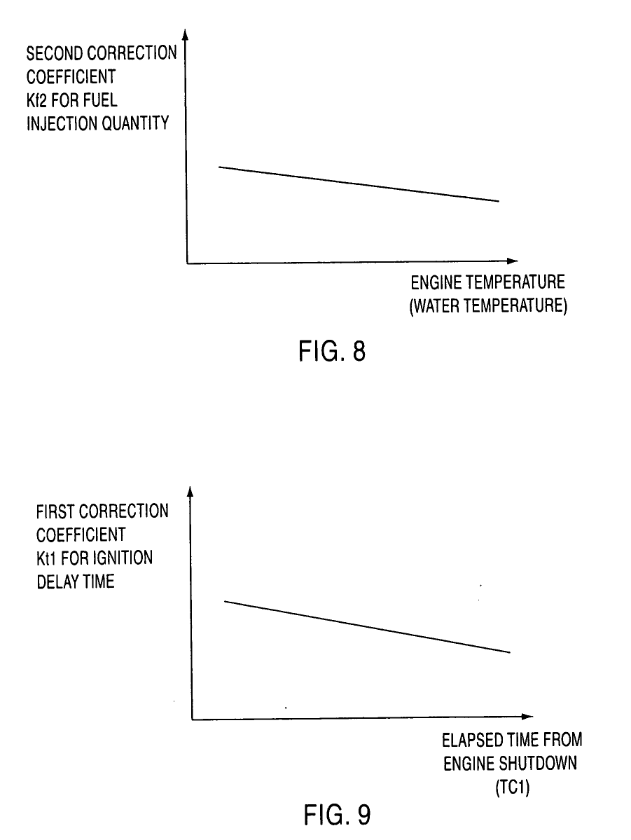

At step S10, a water or coolant temperature (corresponding to engine temperature) is detected by the water temperature sensor 34, and, on the basis of the detected water temperature, a second correction coefficient Kf2 for correcting the basic fuel injection quantity f0 is computed, as represented in the chart shown in FIG. 8. When the engine temperature is low, there is a risk that injected fuel will not be quickly vaporized and will accrete to the cylinder wall or the like, and the proportion of the vaporized fuel will be low in comparison to that at high temperature. Accordingly, in order to achieve the target air-fuel ratio upon starting, the lower the engine temperature as compared to a predetermined temperature or temperature threshold typically existing at the time of engine shutdown, the greater the fuel injection quantity required. The chart shown in FIG. 8 represents this condition. With the second correction coefficient Kf2, the higher the temperature of the engine as compared to the predetermined threshold, the less the fuel injection quantity is corrected (reduction correction).

At step S11, fuel injection quantity F is established by multiplying the basic fuel injection quantity f0 by the first correction coefficient Kf1 and the second correction coefficient Kf2, (F=f0×Kf1×Kf2).

At step S12, on the basis of the count value TC1 of the stop timer (the elapsed time from shutdown of the engine) a first correction coefficient Kt1 for correcting the basic ignition delay time t0 is computed as represented in the chart shown in FIG. 9. As described above, since gas leakage through a piston ring or the like causes a decline in cylinder pressure to reduce after shutdown of the engine, the difference in cylinder pressure causes the vaporization (atomization) characteristic of the injected fuel to vary, resulting in changes in vaporization-stabilizing time and the like (in general, the higher the cylinder pressure as compared to a predetermined pressure or pressure threshold typically existing at the time of engine shutdown, the longer the vaporization-stabilizing time). Accordingly, in order to perform ignition at the most appropriate time, it is necessary to establish an ignition delay time while taking account into the vaporization characteristic (the vaporization-stabilizing time). The chart shown in FIG. 9 has been prepared accordingly. In other words, the first correction coefficient Kt1 serves for estimating a time-lapse change in the cylinder pressure during shutdown of the engine on the basis of the elapsed time from shutdown and for correcting the basic ignition delay time t0 on the basis of the change. For longer elapsed time from shutdown of the engine (i.e., for lower cylinder pressure as compared to the predetermined threshold), the ignition delay time is corrected for further delay (delay correction). Meanwhile, the above-mentioned fuel pressure sensor may be provided to take account fuel pressure when establishing the first correction coefficient Kt1.

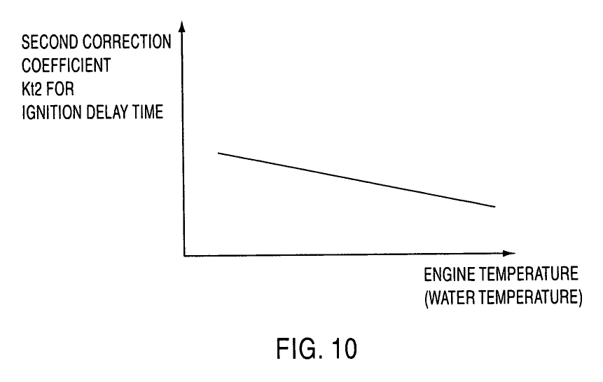

At step S13, on the basis of the water temperature (i.e., the engine temperature), a second correction coefficient Kt2 for correcting the basic ignition delay time t0 is computed as represented in the chart shown in FIG. 10. Since the vaporization characteristic of the injected fuel varies with variations in the combustion chamber temperature, this correction is intended to provide ignition at the most appropriate time while taking account this temperature variation. The chart of FIG. 10 shows that in accordance with this second correction coefficient Kt2, that when the temperature of the engine is relatively high, the ignition delay time is corrected for further delay (delay correction).

At step S14, an ignition delay time Twait is established by multiplying the basic ignition delay time t0 by the first correction coefficient Kt1 and the second correction coefficient Kt2, (Twait=t0×Kt1×Kt2). In the normal temperature condition under the combustion chamber volume at an ideal piston stop position, 150 msec can be adopted as the ignition delay time Twait when the elapsed time corresponds to the condition in which the cylinder pressure is 200 Kpa. In the same condition, 100 msec can be adopted as the ignition delay time Twait when the elapsed time corresponds to the condition in which the cylinder pressure is 100 Kpa. The tardiness until start of the engine can be made a minimum by making the delay time a minimum requirement.

At step S15, a fuel injection command to inject the established fuel injection quantity F is issued to the fuel injection valve 10 of a cylinder on an expansion stroke. Also, an injection timer begins counting. A count value TC₂ of the injection timer corresponds to the time elapsed from (completion of) fuel injection.

At step S16, it is determined whether the elapsed time from fuel injection has reached the ignition delay time Twait (that is, TC₂≧Twait is satisfied). If TC₂≧Twait is satisfied, the process moves to step S17, and an ignition command is issued to the ignition plug 11 of the cylinder on the expansion stroke to effect ignition.

At step S18, the count values of the stop timer and the injection timer are cleared.

According to the first embodiment, at the time of restart after idle-stop, a time-lapse change in the cylinder pressure during shutdown of the engine is estimated on the basis of elapsed time after shutdown, and control parameters; i.e., fuel injection quantity and ignition delay time are corrected on the basis of the estimated time-lapse change in the cylinder pressure, thereby achieving the most appropriate condition of combustion-chamber air-fuel mixture ratio at the time of ignition for restarting. The control unit 30 adjusts a time interval between the fuel injection and the ignition based on an amount of air in the combustion chamber. Accordingly, reliable ignition can be achieved and starting without cranking can be improved.

Also, when it is determined that the elapsed time from shutdown of the engine has exceeded the predetermined time and the cylinder pressure falls below the predetermined value, starting is performed by an assisting means such as a starter motor (combustion starting is assisted, see explanation of step S19 above), whereby reliable starting can be achieved even when the torque necessary for starting can no longer be obtained from combustion-starting alone, due to reduction in the cylinder pressure below a predetermined value.

The second embodiment differs from the first embodiment in that a cylinder pressure sensor (not shown) is provided, and fuel injection quantity and ignition delay time are corrected on the basis of the cylinder pressure so detected and the stop position of the piston 5 is corrected to a position appropriate for combustion starting.

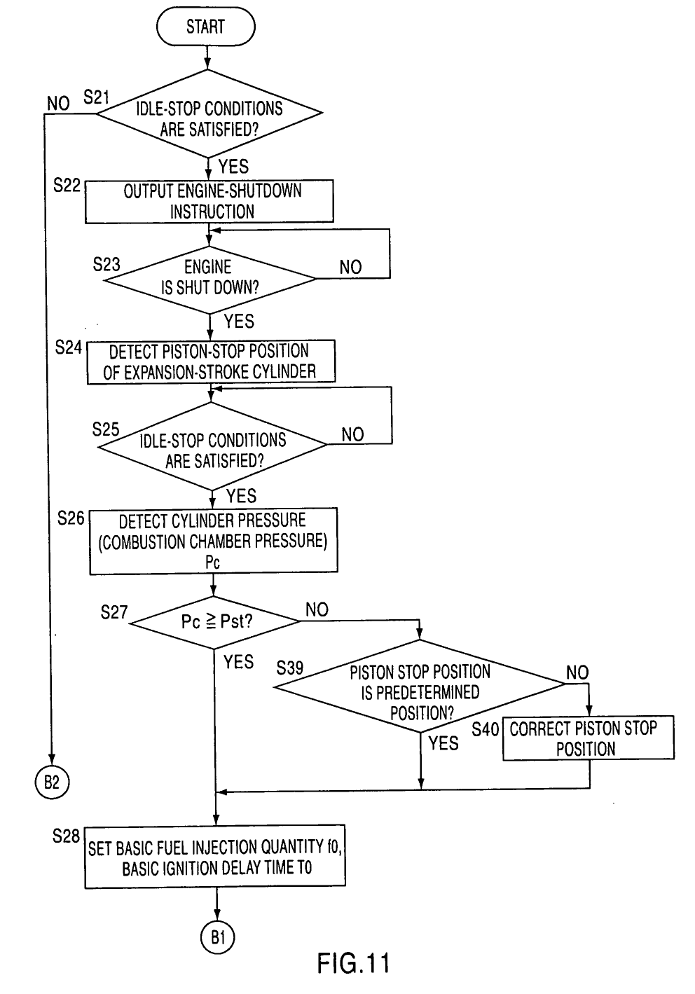

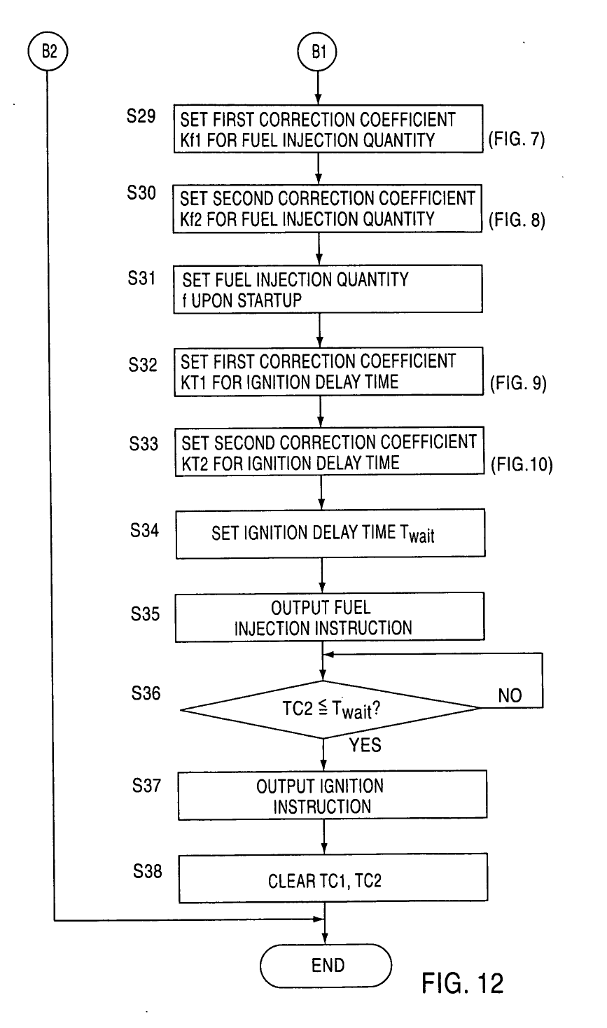

FIGS. 11 and 12 show a flowchart illustrating idle-stop control (shutdown and restart of the engine) according to the second embodiment, executed each predetermined time.

Steps S21 through S24 are the same as steps S1 through S4 shown in FIG. 4. At step S25, in the same fashion as in step S6 shown in FIG. 4, it is determined whether idle-stop releasing conditions (in other words, restart conditions) are satisfied. If the idle-stop releasing conditions are satisfied, the process moves to step S26. If not, the shutdown condition of the engine is maintained without any change.

At step S26, cylinder pressure (combustion chamber pressure) Pc is detected by a cylinder pressure sensor.

At step S27, it is determined whether the detected cylinder pressure Pc is equal to or higher than a predetermined value Ps (Pc≧Ps). If Pc≧Ps, the process moves to step S28. On the other hand, if Pc<Ps, the process moves to step S28 via steps S39 and S40.

At step S39, it is determined whether the piston stop position detected in step S24 coincides with a predetermined position (within a predetermined range). Meanwhile, the predetermined position (range) is established to obtain torque sufficient for starting by fuel injection and ignition and is presumed as, for example, about ATDC 60 degrees with respect to a six-cylinder engine (about ATDC 90 degrees with respect to a four-cylinder engine). If the piston stop position coincides with the predetermined position, the process moves to step S41, and if not, the process moves to step S40.

At step S40, the piston stop position is corrected to the predetermined position. While this correction can be performed with, for example, the starter motor 24, the correction is not limited to this and may be performed in any suitable manner. The process moves to step S28 after correcting the piston stop position.

Steps S28 through S38 are the same as steps S8 through S18 shown in FIGS. 4 and 5.

In the same fashion as in the first embodiment, at the time of restart after idle-stop, a time-lapse change in the cylinder pressure during shutdown of the engine is estimated on the basis of an elapsed time after shutdown, and control parameters; i.e., fuel injection quantity and ignition time (ignition delay time), are corrected on the basis of the estimated time-lapse change in the cylinder pressure, thereby achieving the most appropriate condition of combustion-chamber mixture ratio at the time of ignition for restart. With this, reliable ignition can be achieved and starting without cranking can be improved.

In particular, when the cylinder pressure falls below the predetermined value, the piston stop position (i.e., the combustion chamber volume) is corrected to an appropriate position, and, at the same time, the control parameters; i.e., the fuel injection quantity and the ignition time (the ignition delay time) for combustion starting are corrected on the basis of the detected cylinder pressure, thereby providing the torque necessary for starting and reliably effecting starting without cranking.

While, in the first and second embodiments, both the fuel ignition quantity and the ignition-delay time are corrected with respect to a direct-injection internal combustion engine, the present engine is not so limited. For example, a typical internal combustion engine may be so operated that fuel will remain in a cylinder or that only either one of the fuel ignition quantity and the ignition-delay time need be corrected.

Also, while the basic fuel injection quantity f0 is established and corrected, it may be arranged to correct the air quantity Q in the combustion chamber and to establish the fuel injection quantity required for achieving a target air-fuel ratio based on the corrected air quantity.

Also, while the first and second embodiments are intended for restart in the idle-stop control, they can be applied to starting in general at any time by modifying the foregoing flowcharts as follows. Briefly, in step S1 (or step S21), it is first determined whether an ignition switch is turned off, and if turned off, the process moves to step S2 (or step S22). Then, in step S6 (or step S25), it is determined whether the ignition switch is turned on, and if so, the process moves to step S7 (or step S26). With this modification, starting without cranking is reliably achieved at any time.

In addition, control in the first and second embodiments can be partially exchanged between embodiments. For example, steps S5 and S7 (determination based on the elapsed time from shutdown of the engine) in the first embodiment may be replaced with step S26 (determination based on the detected cylinder pressure) in the second embodiment, or steps S39 and S40 (correction of the piston stop position) in the second embodiment may be added before step S19 (crank starting) in the first embodiment. Thus, even when cylinder pressure is relatively low, quick and reliable starting can be achieved.

While the present engine and method have been described in connection with certain specific embodiments thereof, this is by way of illustration and not of limitation, and the appended claims should be construed as broadly as the prior art will permit.

What is claimed is:

1. An internal combustion engine, comprising:
a fuel injector for injecting fuel into a combustion chamber to produce an air-fuel mixture in the combustion chamber,
an ignition plug for igniting the air-fuel mixture to effect combustion in the combustion chamber, and
a controller for controlling combustion to provide torque for starting the engine after the engine has been stopped,
wherein the controller adjusts a time interval between the fuel injection and the ignition based on an amount of air in the combustion chamber.

2. The internal combustion engine according to claim 1, wherein the controller determines the amount of air in the combustion chamber by determining an amount of time elapsed since the engine was stopped.

3. The internal combustion engine according to claim 1, wherein the controller determines the amount of air in the combustion chamber by determining the pressure in the combustion chamber.

4. The internal combustion engine according to claim 3 further comprising:
a timer determining the amount of time elapsed from the moment when the engine was stopped, and
wherein the controller estimates the pressure based on the elapsed time.

5. The internal combustion engine according to claim 3, further comprising:
a pressure sensor for determining the pressure in the combustion chamber and generating a signal corresponding to the pressure so determined, and
wherein the controller is connected to receive the signal from the pressure sensor.

6. The internal combustion engine according to claim 1, wherein the lower the amount of air in the combustion chamber is as compared to a predetermined threshold, the shorter the time interval is.

7. The internal combustion engine according to claim 1, further comprising:
a temperature sensor for determining a temperature of the engine,
wherein the controller adjusts the time interval based on the temperature of the engine.

8. The internal combustion engine according to claim 7, wherein the higher the temperature is as compared to a predetermined threshold, the shorter the time interval is.

9. The internal combustion engine according to claim 1, further comprising:
a cylinder block having a cylinder bore formed therein,
a cylinder head having an intake passage and an exhaust passage formed therein, the cylinder head being connected to the cylinder block,
a piston slidably disposed in the cylinder bore to define a combustion chamber, and
a piston position sensing device,
wherein the controller determines whether the piston position is in an expansion stroke when the engine has been stopped as sensed by the piston position sensing device, and adjusts the time interval based on the piston position.

10. The internal combustion engine according to claim 1, wherein the controller adjusts an amount of fuel to be injected based on the amount of air in the combustion chamber.

11. The internal combustion engine as claimed in claim 10, wherein the lower the amount of air is, the less the amount of the fuel is.

12. The internal combustion engine according to claim 10, wherein the controller adjusts the amount of the fuel to be injected based on the temperature of the engine.

13. The internal combustion engine according to claim 12, the higher the temperature is as compared to a predetermined threshold, the less the amount of fuel is.

14. The internal combustion engine according to claim 1, further comprising:
a cylinder block having a cylinder bore formed therein,
a cylinder head having an intake passage and an exhaust passage formed therein, the cylinder head being connected to the cylinder block,
a piston slidably disposed in the cylinder bore to define a combustion chamber, and
a piston position sensing device, and
wherein the controller determines whether the piston position is in an expansion stroke after the engine has been stopped and establishes the amount of fuel to be injected based on the piston position sensed by the piston sensing device.

15. The internal combustion engine according to claim 1, further comprising:
a support device for assisting the starting of the engine, and
wherein the controller operates the support device when the pressure in the combustion chamber is lower than a predetermined threshold.

16. The internal combustion engine according to claim 15, wherein the support device is a starter motor for cranking the engine.

17. The internal combustion engine according to claim 15, wherein the support device repositions a piston to a position in an expansion stroke when the engine is stopped.

18. An internal combustion engine, comprising:
a cylinder block having a cylinder bore formed therein,
a cylinder head having an intake passage and an exhaust passage formed therein, the cylinder head being connected to the cylinder block,
a piston slidably disposed in the cylinder bore to define a combustion chamber,
a fuel injector for providing fuel directly into the combustion chamber to produce an air-fuel mixture in the combustion chamber,
an ignition plug operable to ignite combustion of the air-fuel mixture,
a controller for managing the combustion to provide torque for starting the engine after the engine has been stopped, and
a timer for determining time elapsed from the moment the engine was stopped, and
wherein the controller adjusts a time interval between the fuel injection and the ignition of combustion based on the elapsed time.

19. The internal combustion engine according to claim 18, wherein the lower the amount of air in the combustion chamber is, the shorter the time interval is.

20. The internal combustion engine according to claim 19, further comprising:
a temperature sensor for determining a temperature of the engine,
wherein the controller adjusts the time interval based on the temperature of the engine.

21. The internal combustion engine according to claim 20, wherein the higher the temperature is, the shorter the time interval is.

22. The internal combustion engine according to claim 21, further comprising:
a cylinder block having a cylinder bore formed therein,
a cylinder head having an intake passage and an exhaust passage formed therein, the cylinder head being connected to the cylinder block,
a piston slidably disposed in the cylinder bore to define a combustion chamber, and
a piston position sensing device,
wherein the controller determines whether the piston position is in an expansion stroke when the engine has been stopped as sensed by the piston position sensing device, and adjusts the time interval based on the piston position.

23. A direct start internal combustion engine, comprising:
means for determining an amount of air in a combustion chamber, and
means for correcting a time interval between fuel injection into the combustion chamber from an injector and ignition based on the amount of air in the combustion chamber.

24. A method of a starting an internal combustion engine having a combustion chamber, comprising:
determining the amount of air in the combustion chamber,
injecting fuel directly into the combustion chamber,
adjusting a time interval between the injection of fuel and ignition of the air-fuel mixture in the combustion chamber, based on the amount of air in the combustion chamber, and
igniting the air-fuel mixture upon expiration of the adjusted time interval to produce torque to start the engine from a stopped condition.

25. A method of starting an internal combustion engine in a stopped condition, comprising:
effecting ignition-combustion without cranking, and
correcting the ignition-combustion by exercising a control parameter.

26. The method according to claim 25, wherein the control parameter is a correction of the time of ignition based upon a time-lapse change in the cylinder pressure estimated on the basis of time elapsed from the moment of engine stop.

27. The method according to claim 25, wherein the control parameter is an ignition delay time from fuel injection.

28. The method according to claim 26, wherein the greater the cylinder pressure variation over time or the longer the elapsed time from stop of the engine, the more the ignition delay time is corrected for delay.

29. The method according to claim 28, wherein the ignition delay time is further corrected for reduction on the basis of an engine temperature.

30. The method according to claim 29, wherein the higher the engine temperature, the more the ignition delay time is corrected for delay.

31. The method according to claim 30, wherein the ignition delay time is set on the basis of a piston stop position of a cylinder on the expansion stroke during stop of the engine.

32. The method according to claim 26, wherein the control parameter is a fuel injection quantity.

33. The method according to claim 32, wherein the greater the cylinder pressure variation over time or the longer the elapsed time from stop of the engine, the less the fuel injection quantity is corrected to.

34. The method according to claim 33, wherein the fuel injection quantity is further corrected on the basis of an engine temperature.

35. The method according to claim 34, wherein the higher the engine temperature, the less the fuel injection quantity is corrected to.

36. The method according to claim 35, wherein the fuel injection quantity is set on the basis of the piston stop position in a cylinder on an expansion stroke during stop of the engine.

37. The method according to claim 25, including assisting ignition-combustion starting of the engine when the cylinder pressure falls below a predetermined value or the elapsed time from stop of the engine exceeds another predetermined value.

38. The method according to claim 37, wherein the assisting step includes at least one of cranking the engine with a starter motor or adjusting the stop position of the piston.

39. A method of starting an internal combustion engine by ignition-combustion without cranking, wherein a time-lapse change in a cylinder pressure during stop of the engine is detected or estimated, and at least one of a fuel injection quantity and an ignition delay time is corrected on the basis of the cylinder pressure during stop of the engine.
